(19) United States
(12) Patent Application Publication
(10) Pub. No.: US 2002/0198973 A1
(43) Pub. Date: Dec. 26, 2002

(54) System for dynamic customer filtering of management information presented through a web-based portal

(76) Inventor: Lawrence M. Besaw, Ft Collins, CO (US)

Correspondence Address: HEWLETT-PACKARD COMPANY, Intellectual Property Administration, P.O. Box 272400, Fort Collins, CO, 80527-2400, US

(21) Appl. No.: 09/843,760

(22) Filed: Apr. 30, 2001

(51) Int. Cl. G06F 15/173; G09G 5/00

(52) U.S. Cl. 709/223; 345/736

(57) ABSTRACT

In accordance with the principles of the present invention, an information filtering system in a management portal allows dynamic customization of the display of on-line service information for a particular customer of the service to provide substantially relevant information for the customer. In an aspect of the present invention, the on-line service information includes information regarding the network resources provided or managed by a service provider. A management information portal of the management portal includes a module library that contains one or more display modules, which are the generic building blocks each of which provides information dynamically regarding particular aspects of the network resources. The dynamic information filtering system comprises a filter specified in an user configuration database maintained and updated by the service provider, a filter library that provides a variety of filters, where each filter may be applied to information for displayed to the customer. In an embodiment of the present invention, the dynamic information filter system may comprise a security filter that defines what the particular customer is allowed to view and a display filter that defines what the customer desires to view of his/her partitioned network.

### TECHNICAL FIELD

The present invention generally relates to information systems. More particularly, the present invention relates to filtering information presented to customers of a management information portal.

### DESCRIPTION OF RELATED ART

A substantial increase in the use of computers has been seen in recent years, and along with this increase has come an explosion in the use of the Internet. One particular aspect of the Internet that has gained widespread use is the World-Wide- Web (WWW). The WWW is a source of on-line services, e.g., access to the Internet itself, i.e., by an Internet Service Provider (ISP), electronic mail (e-mail) service, network management service or the like.

A service provider may offer a variety of network services to customers. The customer may be a small business, a corporation, an organization or any entity requiring network services. The network services may include Internet services, electronic mail (e-mail) services, network management service and the like. A customer may not prefer to create and/or manage a network to provide network services, which may be driven by a lack of expertise, cost, etc. In order to receive network services, the customer may utilize the service provider to provide for the desired network services. The service provider would then configure a portion of its own network into partitioned (or allocated) networks, each partitioned network allocated to a customer.

For example, in the case of a network management service, a service provider may manage a number of network components for various customers, and may also provide management information such as overall health i.e., the remaining capacity and/or the data throughput of the network components being managed, the topology of the networks being managed, and/or any alarm condition logged or the like, to a customer—typically to an administrator of the managed customer network—through a management portal.

The management portal presents the above described on-line service information, e.g., as a web page, i.e., a hypertext markup language (HTML) page. A customer may utilize a web browser, e.g., the NETSCAPE NAVIGATOR from the Netscape Communications of Mountain View, Calif., USA, or the INTERNET EXPLORER from the Microsoft Corporation of Redmond, Wash., USA, installed on his/her computer to view the web page provided by the management portal through the WWW.

As one of the network services, a service provider may provide the capability to view the service provider network for monitoring and troubleshooting by the customer. However, a customer does not use all of the resources provided by a service provider and/or a service provider manages network resources of several customers through a single management portal. As a result, the information available provided by a management portal may contain portions which may be irrelevant to a particular customer. For example, if a customer utilizes only two out of a hundred routers of a service provider, the information with respect to the other ninety-eight routers not used by the customer is irrelevant to that particular customer.

Presenting a customer with information irrelevant to the particular customer may result in unnecessary effort by the customer requiring the customer to sift through the presented information to find the desired relevant information. This may not only frustrate and/or confuse the customer, it may also be wasteful of the communication bandwidth.

### SUMMARY OF THE INVENTION

In accordance with the principles of the present invention, a method of filtering information displayed to a customer of a management information portal includes providing a plurality of network resources managed by the management information portal and storing a security filter in a configuration record for the customer where the security filter specifies ones of one or more network resources relevant to the customer. The method also includes providing a plurality of modules where each module is configured to provide a respective portal display to the customer and providing a display filter configured to specify one or more network resources relevant to the customer for each module of the plurality of modules. The method finally includes constructing a selected portal display of a selected module where the selected portal display displays information determined from an application of the security filter and a respective display filter of the selected module on the plurality of network resources.

In accordance with another aspect of the principles of the present invention, a computer readable storage medium is embedded with one or more computer programs. The one or more computer programs implementing a method of filtering information displayed to a customer of a management information portal. The one or more computer programs includes a set of instructions for providing a plurality of network resources managed by the management information portal and storing a security filter in a configuration record for the customer where the security filter specifies ones of one or more network resources relevant to the customer. The one or more computer programs also includes providing a plurality of modules where each module is configured to provide a respective portal display to the customer and providing a display filter configured to specify one or more network resources relevant to the customer for each module of the plurality of modules. The one or more computer programs finally includes constructing a selected portal display of a selected module where the selected portal display displays information determined from an application of the security filter and a respective display filter of the selected module on the plurality of network resources.

In addition, in accordance with yet another aspect of the principles of the present invention, a system for filtering information displayed to a customer of a management information portal includes a user configuration database configured to store a security filter for specifying a first subset of a plurality of network resources relevant to the customer in a configuration record for the customer. The configuration record is an entry in the user configuration database. The system also includes a module library including a plurality of modules where each module is configured to provide a respective portal display to the customer. The system further includes a filter library including a plurality of display filters where each display filter is configured to specify a second subset of the plurality of network resources relevant to said customer. Finally, the system includes a display manager configured to construct a selected portal display in response to a selection of a selected module. The selected portal display displays information determined from an application of the security filter and a respective display filter for the selected module

### DESCRIPTION OF THE DRAWINGS

Features and advantages of the present invention will become apparent to those skilled in the art from the following description with reference to the drawings, in which:

FIG. 1 illustrates a system where an exemplary embodiment of the present invention may be practiced therein;

FIG. 2 shows an exemplary embodiment of the management information portal of the on-line service system shown in FIG. 1;

FIG. 3 illustrates an exemplary embodiment of the library module shown in FIG. 2 in accordance with the principles of the present invention;

FIG. 4 illustrates an exemplary block diagram of a security filter in the user configuration database in accordance with the principles of the present invention;

FIG. 5 illustrates a block diagram of a display filter in accordance with the principles of the present invention.

FIG. 6 illustrates an operational example of security filter with an IP host sub- filter enabled and a display filter with a node selection sub-filter enabled on a customer-partitioned network;

FIG. 7 illustrates an exemplary flow diagram of dynamic filtering of information in the management information portal for a customer; and

FIG. 8 illustrates an exemplary computer system 700 where an embodiment of the present invention may be practiced in accordance with the principles of the present invention.

### DETAILED DESCRIPTION OF THE PREFERRED EMBODIMENT

For simplicity and illustrative purposes, the principles of the present invention are described by referring mainly to an exemplar embodiment thereof, particularly with references to an example of an on-line network management service system over the World Wide Web (WWW). However, one of ordinary skill in the art would readily recognize that the same principles are equally applicable to, and can be implemented in, any network and in any communication protocols, and that any such variation would be within such modifications that do not depart from the true spirit and scope of the present invention.

In accordance with the principles of the present invention, an information filtering system in a management portal allows dynamic customization of the display of on-line service information for a particular customer of the service to provide substantially relevant information for the customer. In an aspect of the present invention, the on-line service information includes information regarding the network resources provided or managed by a service provider.

A management information portal of the management portal includes a module library that contains one or more display modules, which are the generic building blocks, each of which provides information dynamically regarding particular aspects of the network resources. The dynamic information filtering system comprises a filter specified in a user configuration database maintained and updated by the service provider, and a filter library that provides a variety of filters, where each filter may be applied to information for display to the customer. In an embodiment of the present invention, the dynamic information filter system may comprise a security filter that defines what the particular customer is allowed to view and a display filter that defines what the customer desires to view of his/her partitioned network.

When a customer logs onto a management information portal through, for example, a user interface web page, the management portal displays only the information that the user is allowed and/or desires to view based on the dynamic information filter system in the configuration record for the particular customer found in the user configuration database.

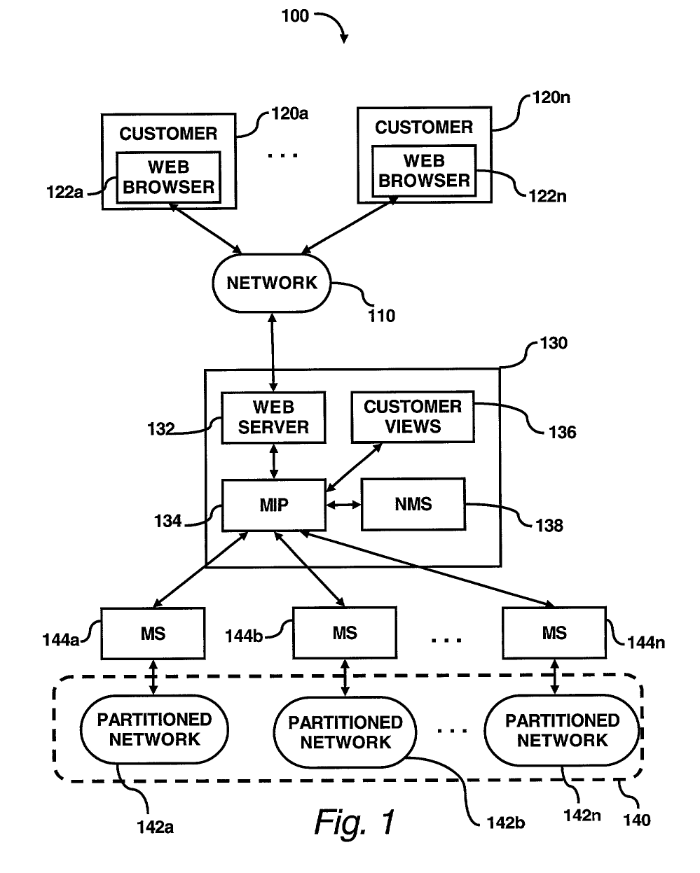

FIG. 1 illustrates an on-line service system 100 where an exemplary embodiment of the present invention may be practiced therein. As shown in FIG. 1, the system 100 includes at least a network 110 interfaced between customers 120 and a management portal 130. The network 110 may be implemented as a local area network, a wide area network, a wireless network, Internet or the like. Although, in the exemplary embodiment, the network 110 may utilize a hypertext transfer protocol (“HTTP”) to provide communication services between the customers 120 and the service provider a variety of other network protocols (TCP/IP, X.25, etc.,) may also be used to provide communication services.

Although, for illustrative purposes, only one network 110 is shown in FIG. 1, it should be understood and readily apparent to those familiar with networks that there may be any number of networks interfacing customers 120 and the management portal 130.

A service provider may offer a variety of network services to customers 120. The customer may be a management information system group, a corporation, an organization, etc. The network services may include Internet services, electronic mail (e-mail) services, network management service and the like. A customer may not prefer to create and/or manage a network to provide network services, which may be driven by a lack of expertise, cost, etc. In order to receive network services, the customer may utilize the service provider to provide for the desired network services. The service provider would then configure a portion of its own network 140 into partitioned networks 142, each partitioned network allocated to a customer.

Once authenticated, a customer 120a may be given access to the management information portal 134 of the management portal 130. The management information portal 134 may be configured to provide customized management services to the customers 120 by referencing a customer views module 136. The customer views module 136 may be configured to maintain a database of the types of services available to each customer in response to being authenticated into the management portal 130.

The management information portal 134 may be further configured to interface with a network management software (“NMS”) 138. The NMS 138 may be configured to provide network management services such as monitoring, diagnosis, and the like to the management information portal 134 for the network 140.

The management information portal 134 may be further configured to interface with management stations 144. The management stations 144 may be configured to provide a management node function for each of the partitioned networks 142.

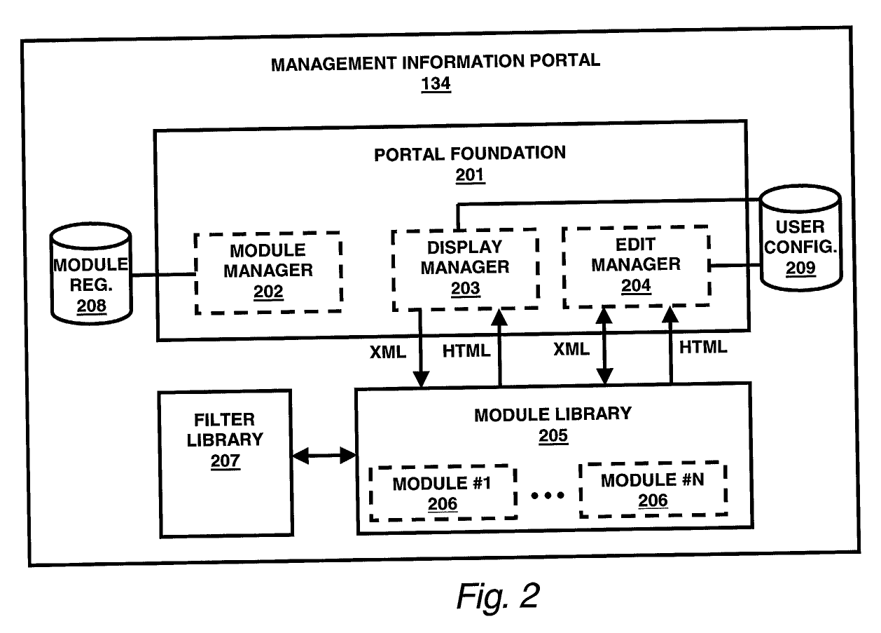

FIG. 2 shows an exemplary embodiment of the management information portal 134 of the on-line service system shown in FIG. 1. The management information portal 134 may comprise a Module Registration (MR) file 208, which may be configure to store a list of modules 206 available in the Module Library (ML) 205. In an embodiment of the present invention, a display to the customer may comprise a hypertext markup language (HTML) page, and each of the modules may include a sub-window within the HTML display page. By way of example, in the case of network management service, the HTML display page may include a sub-window that displays the network health information, another sub-window showing the topology of the network being managed, and yet another sub-window providing a listing of critical event alarm logs.

The management information portal 134 further comprises a portal foundation 201, which may be a program, e.g., common gateway interface (CGI) program or the like, that can be launched by the web server 132. The portal foundation 201 includes a Module Manager (MM) 202, Display Manager (DM) 203 and an Edit Manager (EM) 204. The MM 202 maintains the MR file 208, and provides the list of modules to be displayed during initialization of the management information portal for a particular customer after a login by the end-user. The EM 204 allows the service provider to edit a customer configuration file (not shown), where the configuration file may be implemented as a record, a text file, etc. The user configuration database 209 is a database having stored therein configuration file (or record) for each registered customer of the service. Each configuration record may contain, inter alia, account information of the customer, display preferences, e.g., the color scheme and heading labels of the HTML display page, and security filter definition(s).

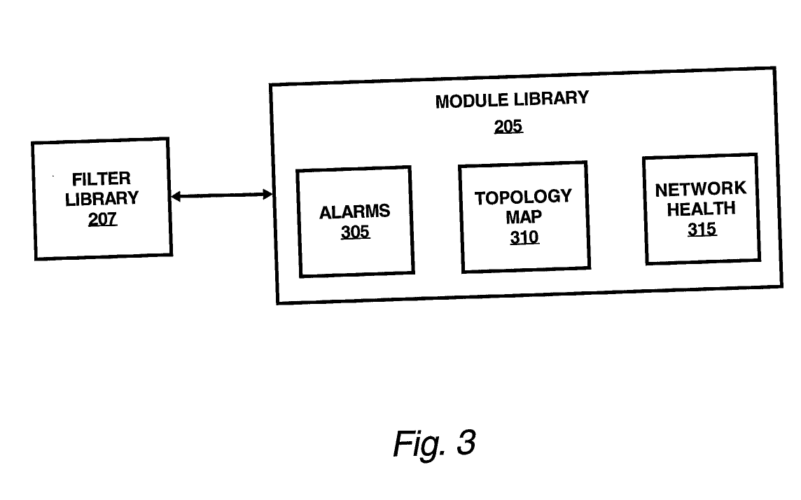

FIG. 3 illustrates an exemplary embodiment of the library module 204 shown in FIG. 2 in accordance with the principles of the present invention. As shown in FIG. 3, the library module 205 includes at least an alarm module 305, a topology map module 310, and a network health module 315. Although FIG. 3 illustrates the alarm module, a topology map module, and a network health module for illustrative purposes only, it is not be construed to be limiting to the present invention in any respect. It should be readily apparent to those skilled in the art that other types of modules may be included in the module library 205 without deviating from the scope or spirit of the present invention.

The alarm module 305 may be configured to display to a customer 120 alarm conditions for the customer's partitioned network 142. The display may be a web page in a markup language format such as HTML, XML and the like, generated by the alarm module 305. The alarm module 305 may be further configured to provide a capability to specify and view the types of alarm categories to be displayed. Additionally, the alarm module 305 may be further configured to provide filtering capability of the display of alarm categories based on the filter library 207.

The topology map module 310 may be configured to provide network topology maps as a management transaction of the management information portal 134 to the customers 120. A network topology map may display the network elements and connections of a customer's partitioned network. Potentially, a network topology map may display a large quantity of information depending on the configuration of the customer's partitioned network. As a result, the topology map module 310 may be configured to access the filters of the filter library 207 to reduce the level of information presented to the customer.

The network health module 315 of the module library 205 may be configured to display a status or health report of a customer's partitioned (or allocated) network 142. The parameters that may indicate the health of a network include input/output operations, data packet traffic, connectivity and the like. Additionally, since the amount of information to be displayed may be large, the network health module 315 may be further configured to access the filters of the filter library 207 to reduce the level of information presented to the customer.

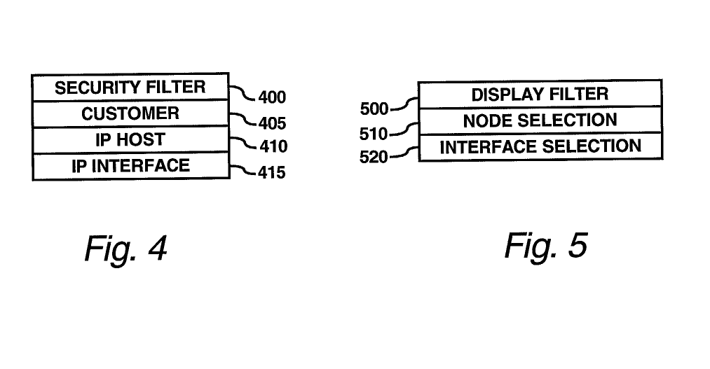

FIG. 4 illustrates an exemplary block diagram of a security filter 400 in the user configuration database 209 in accordance with the principles of the present invention. As shown in FIG. 4, the security filter 400 may be configured to restrict access of a customer to the allocated network of the customer when invoked during a parsing of a customer record in the user configuration database 209. The security filter 400 may be further configured to apply to modules i.e., alarm, network health, topology map, etc., designated in the user configuration database 209 for each customer. Accordingly, a customer may be presented with network information relating to the allocated network services of the customer.

The security filter 400 may include sub-filters such as a customer sub-filter 405, an Internet Protocol (“IP”) host sub-filter 410, and IP interface sub-filter 415. Although FIG. 4 illustrates the customer sub-filter, the IP host sub-filter, and the IP interface sub-filter for illustrative purposes only, it is not be construed to be limiting to the present invention in any respect. It should be readily apparent to those skilled in the art that other types of filters may be included in the security filter 400 without deviating from the scope or spirit of the present invention.

The customer sub-filter 405 may be configured to filter on a customer parameter such as a name, an identification number, or the like. The customer sub-filter uses customer model information supplied externally (external to the management information portal 134) that provides an association of a list of network resources (hosts, interfaces, application services and any type of service provided to a customer) and the particular customer. In other words, by specifying a customer name in the customer sub-filter 405, the customer name is mapped to the network resources managed by the management information portal 134 into a set of customer network resources. The customer network resources may subsequently be used for additional filtering by other filters. The customer sub-filter 405 may be further configured to apply on a node and/or interface level of an allocated network of a customer. Accordingly, by utilizing the customer sub-filter 405 may reduce the nodes and/or interfaces of the service provider network to the allocated network of the customer.

The IP host sub-filter 410 may be configured to filter on a network name e.g., domain name, uniform resource locator, etc., of a network device in an allocated network of a customer. The IP host sub-filter 410 may be further configured to apply to network nodes only of an allocated network of a customer. Thus, when the IP host sub-filter 410 is enabled, a customer may display information of the customer's allocated network based on a network name of a network node and/or interface.

The IP interface sub-filter 415 may be configured to filter on an IP address of a network device. The IP interface sub-filter 415 may be further configured to apply on interfaces of an allocated network of a customer. Accordingly, a customer may display information of his/her allocated network based on an IP address of a network device in response to enabling the IP interface sub-filter 415.

As described herein above, the security filter 400 may be applied to all modules in the module library 205 designated by the customer in the user configuration database 209. However, other filters from the filter library 207 may be applied to the designated modules. For instance, a display filter may be applied to each individual module.

FIG. 5 illustrates a block diagram of a display filter 500 in accordance with the principles of the present invention. The display filter 500 may be configured to each of the module, e.g., alarm, network health, topology map, etc., of the module library 205. The display filter 500 may be further configured to further filter the information from the security filter 400. Thus, by applying both the security and display filters, a customer may be presented with the network information most applicable to the customer.

The display filter 500 may include a node selection sub-filter 510 and an interface selection sub-filter 520. The node selection sub-filter 510 may be configured to further restrict the set of network nodes of an allocated network that are displayed to a customer. The interface selection sub-filter 520 may be configured to further restrict the set of interfaces of an allocated network that are displayed to a customer.

In a preferred embodiment of the present invention, the user configuration database 209, and the filters of the filter library 207 may be specified using extensible mark-up language (“XML”) or other type of mark-up language. An exemplary embodiment of a security filter 400 is shown in Table I and a display filter 500 is shown in Table II below:

TABLE I
Security Filter

<SecurityFilter>

<CustomerFilter>

<Customer name=”Customer #n”/>

</CustomerFilter>
<IPHostFilter>

<IPHost hostname=”host#1”/>
<IPHost hostname=”host#k”/>

</IPHostFilter>
<IPInterfaceFilter>

<IPInterface IPAddr=”35.30.10.1”/>
<IPlnterface IPAddr=”35.30.10.2”/>

</IPInterfaceFilter>

</SecurityFilter>

TABLE II
Display Filter

<DisplayFilter>

<CustomerFilter>

<Customer name=”Customer #n”/>

</CustomerFilter>
<IPHostFilter>

<IPHost hostname=”host#1”/>

</IPHostFilter>
<IPInterfaceFilter>

<IPInterface IPAddr=”35.30.10.1”/>

</IPInterfaceFilter>

</DisplayFilter>

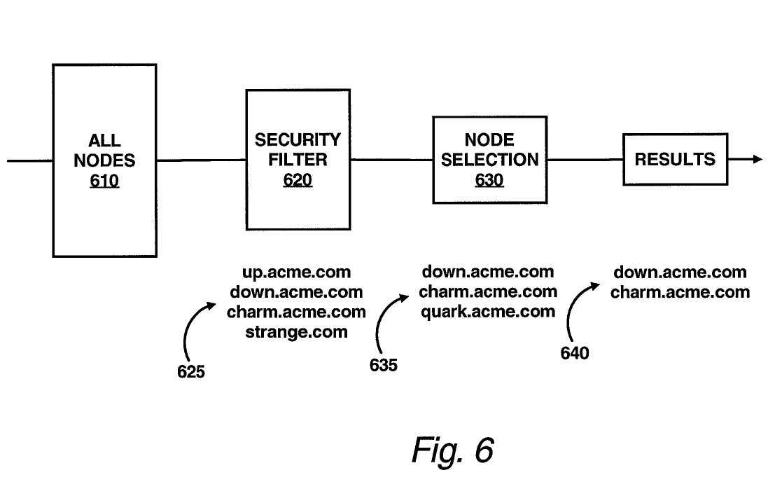

FIG. 6 illustrates an operational example of security filter with an IP host sub-filter enabled and a display filter with a node selection sub-filter enabled on a customer-partitioned network. In particular, with reference to FIGS. 1-5 together, nodes 610 may represent the nodes and interfaces of a service provider network 140, shown in FIG. 1. When a user from a customer 120a logs into the management information portal 134, the user configuration database 209 may be accessed to invoke a security filter 620 to determine a set of nodes and interfaces of the service provider 140 that are applicable to the customer 120a. Moreover, if the IP host sub-filter of the security filter 620 is enabled, a first subset of nodes 625 may be created, thereby reducing the service provider network 140 to a portion of the customer's allocated network.

Moreover, when the user enables a module, e.g., alarm module 305, to display alarm conditions for the partitioned network, the alarm module 305 may be configured to access the display filter 630 from the filter library 207. If the user has enabled the node selection sub-filter of the display filter 630, a second subset of nodes 635 may be created. The management information portal 134 may be configured to apply a union to results of the security filter 620 and the display filter 630 to create a resulting list of nodes which alarm conditions are displayed by the alarm module.

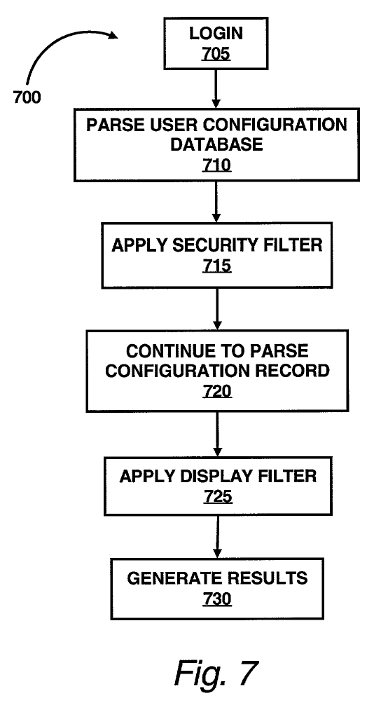

FIG. 7 illustrates an exemplary flow diagram of dynamic filtering of information in the management information portal 134 for a customer. In particular, in step 705, a customer logs into management portal 130. The web server 132 may perform a verification procedure, e.g., of the customer as a security measure. Once the customer has passed the verification procedure, the management information portal 134 may be configured to access the user configuration database 209 to determine an appropriate display setting for the customer, in step 710. As part of the determination of the display setting for the customer, the security filter found in the user configuration database 209 is applied to the service provider network 140 to a first subset of nodes and/or interfaces, depending which sub-filters have been enabled, in step 715.

In step 720, the management information portal 134 may further parse the configuration record of the customer in the user configuration database 209 to determine which modules from the library module 205 are applicable to the customer. A display filter is applied to the network 140 to create a respective second subset of nodes and/or interfaces for each module depending on which sub-filters have been enabled, in step 725.

The management information portal 134 may be further configured to determine a union of the first subset of nodes and/or interface with a respective second subset of nodes and/or interfaces of each module, in step 730. The resulting nodes and/or interfaces for the module may then display each module.

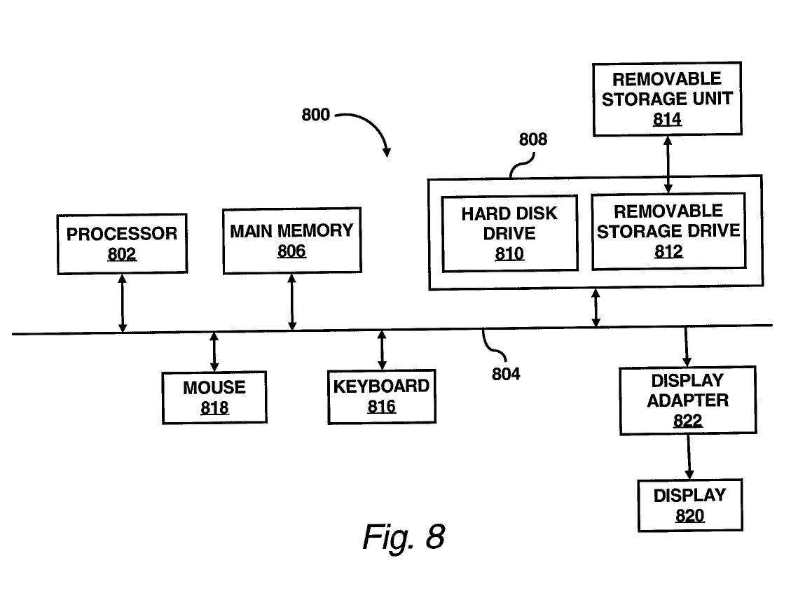

FIG. 8 illustrates an exemplary computer system 800 where an embodiment of the present invention may be practiced in accordance with the principles of the present invention. The functions of the management information portal 134 are implemented in program code and executed by the computer system 800. In particular, the computer system 800 includes one or more processors, such as a processor 802 that provides an execution platform for the management information portal 134. Commands and data from the processor 802 are communicated over a communication bus 804. The computer system 800 also includes a main memory 806, preferably Random Access Memory (RAM), where the software for the management information portal 134 is executed during runtime, and a secondary memory 708. The secondary memory 808 includes, for example, a hard disk drive 810 and/or a removable storage drive 812, representing a floppy diskette drive, a magnetic tape drive, a compact disk drive, etc., where a copy of software for the management information portal 134 may be stored. The removable storage drive 812 reads from and/or writes to a removable storage unit 814 in a well-known manner. A customer from the service provider may interface directly with the management information portal 134 with a keyboard 816, a mouse 818, and a display 820. A display adaptor 822 interfaces with the communication bus 804 to receive display data from the processor 802 and converts the display data into display commands for the display 820.

The present invention may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. In particular, although the method of the present invention has been described by examples, the steps of the method may be performed in a different order than illustrated or simultaneously. Those skilled in the art will recognize that these and other variations are possible within the spirit and scope of the invention as defined in the following claims and their equivalents.

What is claimed is:

1. A method of filtering information displayed to a customer of a management information portal, comprising:
providing a plurality of network resources managed by said management information portal;
storing a first filter in a configuration record of said customer, said first filter specifying one or more network resources relevant to said customer;
providing a plurality of modules, each module configured to provide a respective portal display to said customer;
providing a second filter configured to specify one or more network resources relevant to said customer for each module of said plurality of modules; and
constructing a selected portal display of a selected module, said selected portal display displaying information determined from an application of said first filter and a respective second filter of said selected module on said plurality of network resources.

2. The method of filtering information in accordance with claim 1, further comprising:
specifying at least one sub-filter of a plurality of sub-filters of said first filter, said sub-filter configured to specify one or more network resources relevant to said customer; and
applying said at least one sub-filter of said plurality of sub-filters of said first filter to said plurality of network resources to create a first subset of said plurality of network resources.

3. The method of filtering information in accordance with claim 2, wherein said at least one sub-filter includes a customer filter, said customer filter configured to map a customer name to a set of relevant network resources from said plurality of network resources.

4. The method of filtering information in accordance with claim 2, further comprising:
specifying at least one sub-filter of a second plurality of sub-filters of said second filter; and
applying said least one sub-filter of said second plurality of sub-filters of said second filter to said plurality of network resources to create a second subset of said plurality of network resources.

5. The method of filtering information in accordance with claim 4, wherein said application is a union of said first subset and second subset of plurality of network resources.

6. The method of filtering information in accordance with claim 5, further comprising:
invoking said first filter by parsing a customer record in said user configuration database.

7. The method of filtering information in accordance with claim 6, further comprising:
invoking said selected second filter by invoking said selected module.

8. The method of filtering information in accordance with claim 7, wherein:
said plurality of modules comprises at least one of a network health module, a network topology module and a alarm module, said network health module providing information with respect to health of said network resources, said network topology module providing a graphical representation of a topology of said network resources, and said alarm module providing information with respect to occurrences of critical events in said network resources.

9. The method of filtering information in accordance with claim 1 wherein said first filter includes a security filter and said second filter includes a display filter.

10. A computer readable storage medium on which is embedded one or more computer programs, said one or more computer programs implementing a method of filtering information displayed to a customer of a management information portal, said one or more computer programs comprising a set of instructions for:
providing a plurality of network resources managed by said management information portal;
storing a first filter in a configuration record for said customer, said first filter specifying one or more network resources relevant to said customer;
providing a plurality of modules, each module configured to provide a respective portal display to said customer;
providing a second filter configured to specify one or more network resources relevant to said customer for each module of said plurality of modules; and
constructing a selected portal display of a selected module, said selected portal display displaying information determined from an application of said first filter and a respective second filter of said selected module on said plurality of network resources.

11. The computer readable storage medium in accordance with claim 10, wherein said one or more computer programs further comprising a set of instructions for:
specifying at least one sub-filter of a plurality of sub-filters of said first filter, said sub-filter configured to specify one or more network resources relevant to said customer; and
applying said at least one sub-filter of said plurality of sub-filters of said first filter to said plurality of network resources to create a first subset of said plurality of network resources.

12. The computer readable storage medium in accordance with claim 11, said one more computer programs further comprising a set of instructions for:
specifying at least one sub-filter of a second plurality of sub-filters of said second filter; and
applying said least one sub-filter of said second plurality of sub-filters of said second filter to said plurality of network resources to create a second subset of said plurality of network resources.

13. The computer readable storage medium in accordance with claim 12, wherein said application is a union of said first subset and second subset of plurality of network resources.

14. The computer readable storage medium in accordance with claim 13, wherein said one or more computer programs further comprising a set of instructions for:
invoking said first filter by parsing a customer record in said user configuration database.

15. The computer readable storage medium in accordance with claim 14, wherein said one or more computer programs further comprising a set of instructions for:
invoking said selected second filter by invoking said selected module.

16. The computer readable storage medium in accordance with claim 14, wherein:
said plurality of modules comprises at least one of a network health module, a network topology module and a alarm module, said network health module providing information with respect to health of said network resources, said network topology module providing a graphical representation of a topology of said network resources, and said alarm module providing information with respect to occurrences of critical events in said network resources.

17. A system for filtering information displayed to a customer of a management information portal, comprising:
a user configuration database configured to store a first filter in a configuration record for said customer, said configuration record being an entry in said user configuration database, said first filter specifying a first subset of a plurality of network resources relevant to said customer;
a module library comprising a plurality of modules, each module configured to provide a respective portal display to said customer;
a filter library comprising a plurality of second filters, each second filter configured to specify a second subset of said plurality of network resources relevant to said customer and
a display manager configured to construct a selected portal display in response to a selection of a selected module, said selected portal display displaying information determined from an application of said first filter and respective second filter for said selected module.

18. The system for filtering information in accordance with claim 17, wherein said security filter includes at least one sub-filter of said first filter specifying a first portion of said first subset of said plurality of network resources.

19. The system for filtering information in accordance with claim 18, wherein said respective display filter for said selected module includes at least one sub-filter of said respective display filter specifying a first portion of said second subset of said plurality of network resources.

20. The system for filtering information in accordance with claim 17, wherein said application is a union of said first subset and second subset of said plurality of network resources.
